(19) United States
(12) Patent Application Publication
(10) Pub. No.: US 2003/0117249 A1
(43) Pub. Date: Jun. 26, 2003

(54) Inductive component and method for the production thereof

(76) Inventor: Mathias Klenk, Loechgau (DE)

Correspondence Address: Striker Striker & Stenby, 103 East Neck Road, Huntington, NY, 11743, US

(21) Appl. No.: 10/221,884

(22) PCT Filed: Feb. 7, 2002
(86) PCT No.: PCT/DE02/00448

(30) Foreign Application Priority Data
Feb. 20, 2001 (DE) 101 07 869.2

(51) Int. Cl. H01F 27/02

(52) U.S. Cl. 336/90

(57) ABSTRACT

The invention relates to an inductive component, having a coil (3) disposed in an injection molded housing (2) and having conductor rails (4), also mounted in the housing (2), to each of which the ends of the coil wires are contacted in the form of connection wires (7). Each of the connection wires (7) between the coil (3) and the respective conductor rail (4) forms one composite structure, comprising windings and twists, with a film (8) located between and/or outside them. The injection molding compound of the housing (2) can be applied directly to these composite structures. Preferably, the composite structure comprises at least two windings, which are twisted together and are disposed in the direction of the course of the connection wires (7).

### PRIOR ART

The invention relates to an inductive component, in particular an inductive sensor, as generically defined by the preambles to the main claim and the method claim.

From European Patent Disclosure EP 0 632 897 B1, an inductive rpm sensor is known in which an electrical coil is disposed in a housing in such a way that a change in magnetic field, for instance, can be detected by a rotating part in the region of a pole pin of the coil core, and an rpm sensor can thus be constructed. This rpm sensor, in the area of interest here, comprises a conductor rail, the connection wire of the coil, and the coil itself. It is usual here that to sheathe this region, an injection molding compound is sprayed directly onto the region of the conductor rail, on which the ends of the windings of the coil [verb missing].

Because of the different coefficients of expansion between the injection molding compound and the connection wire, the latter as a rule being of copper, a relative motion can occur between these two materials if there are temperature changes. Since temperature changes thus constantly subject the coil wire to alternating mechanical stress, in an extreme case a fatigue rupture can ensue in the region between the conductor rail and the coil, or the coil-wire-conductor rail arrangement, which can lead to the complete failure of the inductive component. In the known arrangement referred to at the outset, an elastic gel, for instance, is applied retroactively in the region of the connection wires and then wrapped with a film so that the gel will not be forced away from the spray-coating compound.

### ADVANTAGES OF THE INVENTION

According to the invention, in an inductive component of the type defined at the outset, the connection wires between the coil and the respective conductor rail advantageously each form one composite structure, comprising windings and twists, with a film located between them and/or outside of them, and that the injection molding compound of the housing can be applied directly to these composite structures. Preferably, the composite structure comprises at least two windings, which are twisted together with one another and are disposed in the direction of the course of the connection wires. The film can advantageously be produced from polytetrafluoroethylene (PTFE) or polyimide (PI).

In an especially advantageous embodiment of the invention, the inductive component is an inductive sensor, in which the coil is applied to a magnet core, at one pole pin of which a change in magnetic field is detectable by means of metal parts moved past it on the outside. With the conductor rails, an electrical signal can be carried from the coil to terminals of a contact array in the housing of the component.

As noted at the outset, a temperature stress in the inductive component can occur as a result of different expansion, resulting in particular from different coefficients of longitudinal expansion of the plastic spray coating of the housing and of the coil-wire-conductor rail arrangement. Because of the twisted-in film, a protection forms around the wound composite structure, and this protection not only lessens or even completely prevents prior damage to the wire but at the same protects the coil wire against prior stress from the spray coating. Moreover, the protection, with a suitable choice of material, assures some play and slidability between the connection wire and the spray coating when the temperature-caused expansion occurs.

In an advantageous method for producing an inductive component, the connection wires of the coil are placed onto arbors in order to produce the windings of the composite structure. Then in a simple way the film can be placed between individual wires, and subsequently the composite structure of connection wires can be twisted, including the film in it.

These and further characteristics of preferred refinements of the invention are disclosed not only in the claims but also in the description and the drawings; the individual characteristics on their own, or a plurality of them in the form of subsidiary combinations may be realized in the embodiment of the invention and in other fields as well and may represent both advantageous and intrinsically patentable embodiments for which patent protection is here claimed.

### DRAWING

One exemplary embodiment of an inductive component of the invention will be explained in conjunction with the drawing. Shown are:

FIG. 1, a section through an rpm sensor, as an inductive component, with a coil;

FIG. 2, a detail of the windings of the connection wires of the coil, with a film, before twisting;

FIG. 3, a detail of three windings of the coil, with a film located between them;

FIG. 4, a detail of three already-twisted windings; and

FIG. 5, a section through the twisted windings of FIG. 4.

### DESCRIPTION OF THE EXEMPLARY EMBODIMENT

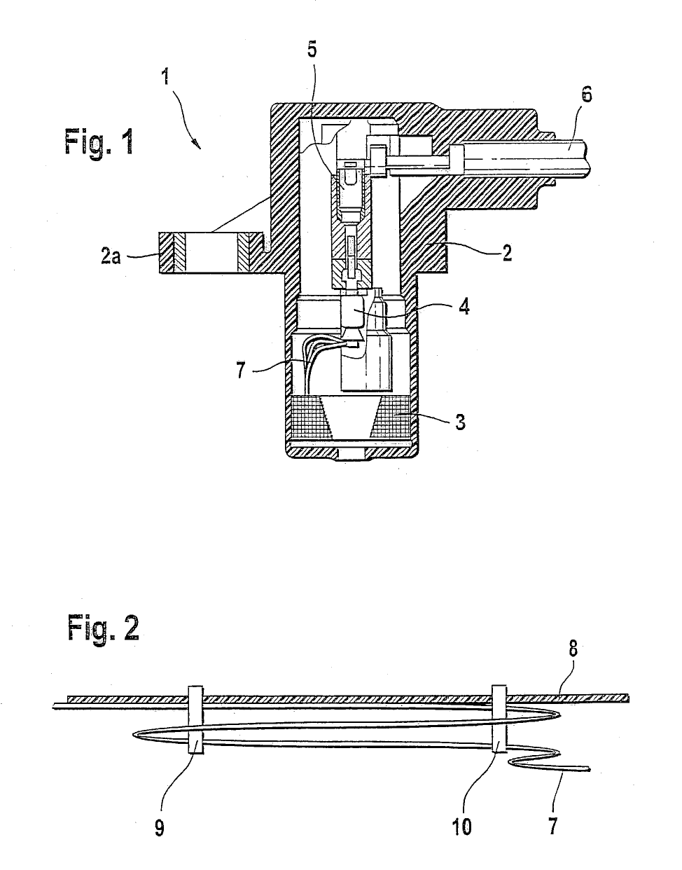

In FIG. 1, an rpm sensor 1 is shown, which has a housing 2 produced by injection molding. A coil 3 is located in the housing 2, and two conductor rails 4 are connected to it, only one of which is visible in FIG. 1. The ends of the conductor rails 4 are connected to a contact array 5, to which a cable 6 leading to the outside can be connected. For mechanically fastening the rpm sensor 1 to a vehicle housing, for instance, a flangelike extension 2a is embedded on the housing 2.

The ends of the conductor rails 4 that are located toward the coil are designed such that secure contacting of the connection wires 7 of the coil 3 can be performed here. The embodiment of these connection wires 7 is shown only schematically in FIG. 1. The design, according to the invention, of the connection wires 7 in the twisted composite structure with a film will now be explained in conjunction with the other drawings. Toward the bottom, that is, toward a gear wheel, not shown, or other body of rotation whose rotational motion is to be determined, a magnet core acting as a so-called pole pin is built into the coil 3; this magnet core protrudes through the coil 3, and the body of rotation comprises magnetically conductive material, in particular, and in a manner known per se generates a measurement signal in the coil 3. The entire coil body is preferably produced by a plastic injection molding process, in which the magnet core and pole pin are then enclosed by the plastic.

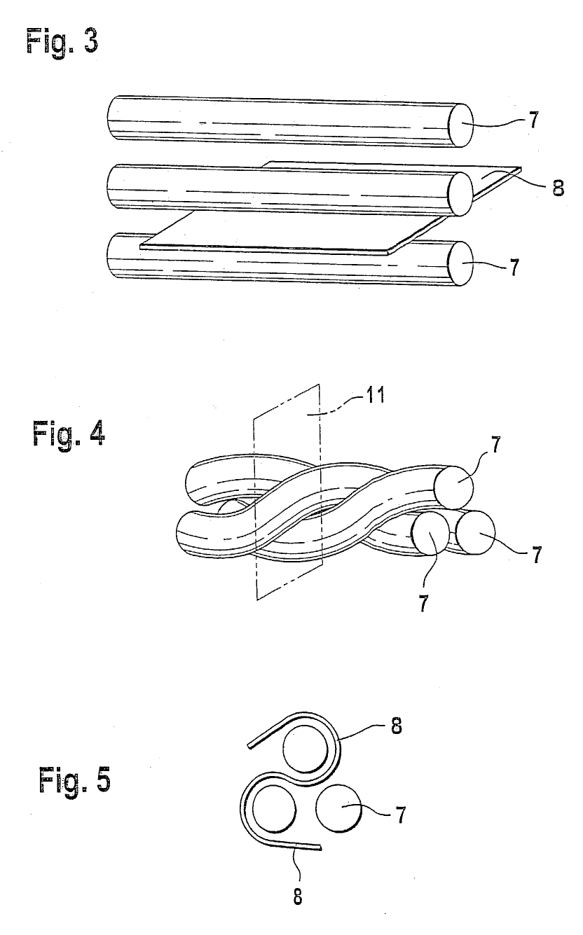

In FIG. 2, a film 8, for instance comprising PTFE or PI, is shown in section; it is spiked onto so-called winding arbors 9 and 10, so as later to become part of the wound composite structure along with the connection wires 7, which are wrapped around the arbors 9 and 10. The initial layer can be seen in FIG. 3; depending on the number of wires 7, various layers are possible. The film 8 can also be placed between the individual winding layers of wire 7, in order to protect quite specific regions in the composite structure. The width and thickness of the film 8 should be adapted to the manufacturing system and to the possible geometries of the coil body 3.

The task of the film 8 is to protect the connection wire 7, or the entire wire twist as seen from FIG. 4, in the composite structure from the surrounding medium, that is, in this case the spray coating composition of the housing 2. In addition, the film assures a certain clearance between the wire 7 and the surrounding medium, which is necessary above all when the materials used have different coefficients of longitudinal expansion.

The production of a triply twisted wire composite structure shown here as an example is done such that first, the wires 7 are stacked together with the film 8 before the twisting is done (FIGS. 2 and 3). Next, the wires 7 together with the film 8 are twisted; FIG. 4 shows the twisted composite structure without the film 8, for the sake of simplicity. In the twisting process, the film 8 is clamped between the wires 7 and can no longer slip.

In FIG. 5, a section 11 in FIG. 4 taken through the twisted composite structure now shows the location of the film 8 in the composite structure. It is clear from this how the protection of the entire composite structure is achieved. The width of the film 8 should be selected such that the composite structure is completely surrounded. Even if small parts of one of the wires 7 are not completely covered by the film 8, the film 8 still prevents a solid, positive and nonpositive fixation of the twisted composite structure by means of the surrounding medium.

1. An inductive component, having
a coil (3), disposed in an injection molded housing (2), and having conductor rails (4), also mounted in the housing (2), to which conductor rails the ends of the coil wires are each contacted, in the form of connection wires (7), characterized in that
the connection wires (7) between the coil (3) and the respective conductor rail (4) each form one composite structure, comprising windings and twists, with a film (8) located between them and/or outside of them, and that
the injection molding compound of the housing (2) can be applied directly to these composite structures.

2. The inductive component of claim 1, characterized in that
the composite structure comprises at least two windings, which are twisted together with one another and are disposed in the direction of the course of the connection wires (7).

3. The inductive component of claim 1 or 2, characterized in that
the film (8) is made from polytetrafluoroethylene (PTFE) or polyimide (PI).

4. The inductive component of one of the foregoing claims, characterized in that
the inductive component is an inductive sensor, in which the coil (3) is applied to a magnet core, at one pole pin of which a change in magnetic field is detectable by means of metal parts moved past it on the outside, and that
with the conductor rails (4), an electrical signal can be carried from the coil (3) to terminals of a contact array (5) in the housing (2) of the component.

5. A method for producing an inductive component of one of the foregoing claims, characterized in that
the connection wires (7) of the coil (3) are wound onto arbors (9, 10) in order to produce the windings of the composite structure; that
at least between two windings the film (8) is placed; and that
subsequently, the windings of the connection wires (7) are twisted, incorporating the film (8) among them.
